(19) United States
(12) Patent Application Publication
(10) Pub. No.: US 2022/0309468 A1
(43) Pub. Date: Sep. 29, 2022

(54) SYSTEM AND A METHOD FOR ARTIFICIAL INTELLIGENCE BASED RESUME BUILDER

(71) Applicant: KUNITE Consulting Pvt. Ltd., Bangalore (IN)

(72) Inventor: Shweta Mahajan, Hyderabad (IN)

(73) Assignee: KUNITE Consulting Pvt. Ltd.

(21) Appl. No.: 17/366,055

(22) Filed: Jul. 2, 2021

(30) Foreign Application Priority Data
Mar. 23, 2021 (IN) 202141012423

(51) Int. Cl. G06Q 10/10; G06Q 10/06; G06N 5/02

(52) U.S. Cl. CPC G06Q 10/1053; G06Q 10/06393; G06N 5/02

(57) ABSTRACT

An artificial intelligence-based resume builder system and method is provided to create user customized resume. The system and the method comprise a plurality of submodules. One or more job roles are received, and one or more skills are received corresponding to each of the one or more job roles. One or more documental proofs are recorded corresponding to each of the one or more skills. A first rating is received from the user for each of the one or more skills. A second rating for each of the one or more skills is generated by examining the one or more documental proofs. An artificial intelligence-based data normalization procedure is executed, combining the first rating and the second rating to determine a final rating. A visual resume is generated based on the job roles received, skills received corresponding to job roles, and the final ratings determined for skills.

### EARLIEST PRIORITY DATE

This application claims priority from a complete patent application filed in India having Patent Application No. 202141012423, filed on Mar. 23, 2021, and titled “A SYSTEM AND A METHOD FOR ARTIFICIAL INTELLIGENCE BASED RESUME BUILDER”.

### FIELD OF INVENTION

Embodiments of the present disclosure relate to a resume management system and more particularly to an Artificial Intelligence-based resume builder system and method for creating user customized resume.

### BACKGROUND

Generally, any recruitment process mainly includes three essential phases: 1 identifying jobs vacancy and analysing job requirements, 2 receiving resumes and 3 shortlisting the resumes and weeding out unqualified applicants. Recruiters need to analyse a lot of the resumes with them, in the recruitment process.

Shortlisting of the resumes by the recruiters is a fast-paced activity. The recruiters do not have time to read each and every resume fully, to decide upon which applicant to shortlist. Therefore, it becomes crucial for an applicant to prepare his resume in a best presentable manner, clearly highlighting all skills, qualifications and work experiences in minimum words. If the resume is too long and verbose, necessary part of the resume may get missed out from eyes of the recruiters. Therefore, a simplified, short but precise information gathering in the resume is important to ensure shortlisting of the applicant for any job position.

Further, explaining each and every key point (skills and work experiences) in words, and yet keeping the resume short, is a challenging task. Explanation in great deal for each and every key point may induce unclarity and may make the resume lengthy, complex, and difficult to be comprehended by the recruiter. Further, it may not be possible to explain the numerous skills an individual keeps gaining. Also, writing at length about project work may bring confidentiality breach issues for the user.

Further, nowadays, hiring or recruiting has become more data driven rather than process driven, and organizations are relying on data more than human judgements. Hence, it is important to build the resume which can be created easily, which is accurate, which is short, and data driven, and which can be processed at ease.

Conclusively, creating the resume is quite a pain stacking task and going over the resume to find out applicants' real skill is even more painful. Multiple rounds of interview are conducted to map the skill set rating for any given applicant. To holistically compare multiple applicants' skill set with other applicants equally is time & resource consuming.

Hence, there is a need for a system and method for creating user customized resume in order to address the aforementioned issues.

### SUMMARY

This summary is provided to introduce a selection of concepts, in a simple manner, which is further described in the detailed description of the invention. This summary is neither intended to identify key or essential inventive concepts of the subject matter nor to determine the scope of the invention.

In accordance with a first embodiment of the present disclosure, an Artificial Intelligence based resume builder system to create user customized visual resume is disclosed. The artificial intelligence-based resume builder system includes one or more hardware processors and a memory coupled to the one or more hardware processors. The memory includes a plurality of submodules in the form of programmable instructions executable by the one or more hardware processors.

The plurality of submodules includes a job role receiver submodule configured to receive one or more job roles from a user. The plurality of submodules includes a skill receiver submodule configured to receive one or more skills from the user corresponding to each of the one or more job roles. The plurality of submodules includes a recorder submodule configured to record one or more documental proofs from the user corresponding to each of the one or more skills. The plurality of submodules includes a skill-set rating submodule configured to receive a first rating from the user for each of the one or more skills, and to generate a second rating for each of the one or more skills by examining the one or more documental proofs based on one or predefined criteria.

The plurality of submodules includes a normalization submodule configured to determine a final rating for each of the one or more skills by normalizing the first rating and the second rating corresponding to each of the one or more skills using an artificial intelligence-based data normalization technique The plurality of submodules comprises a resume generator submodule configured to generate a visual resume based on the one or more job roles received from the user, the one or more skills received from the user corresponding to the one or more job roles, and a final rating determined for each of one or more skills. The visual resume comprises a graphical representation of the one or more skills corresponding to each of the job roles.

Embodiments of the present disclosure also discloses an artificial intelligence-based resume builder method to create user customized visual resume. The artificial intelligence-based resume builder method includes first step of receiving one or more job roles from a user. The artificial intelligence-based resume builder method includes second step of receiving, one or more skills from the user corresponding to each of the one or more job roles. The artificial intelligence-based resume builder method includes third step of recording one or more documental proofs from the user corresponding to each of the one or more skills. The artificial intelligence-based resume builder method includes fourth step of receiving, a first rating from the user for each of the one or more skills. The artificial intelligence-based resume builder method includes fifth step of generating, a second rating for each of the one or more skills by examining the one or more documental proofs based on one or predefined criteria.

The artificial intelligence-based resume builder method includes sixth step of executing, an artificial intelligence-based data normalization procedure to combine the first rating and the second rating corresponding to each of the one or more skills to determine a final rating for each of the one or more skills. The artificial intelligence-based resume builder method includes seventh step of generating, a visual resume based on the one or more job roles received from the user, the one or more skills received from the user corresponding to the one or more job roles, and a final rating determined for each of the one or more skills. The visual resume includes a graphical representation of the one or more skills corresponding to each of the job roles.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for creating user customized visual resume, in accordance with an embodiment of the present disclosure;

FIG. 2 illustrates an exemplary graphical representation of one or more skills created by the Artificial Intelligence based resume builder system, in accordance with an embodiment of the present disclosure;

FIG. 3 is a block diagram illustrating an exemplary artificial intelligence-based resume builder system for segregating visual resumes for a job description to a recruiter, in accordance with an embodiment of the present disclosure;

FIG. 4 is a block diagram illustrating an exemplary processing environment for creating user customized visual resume and for segregating visual resumes for a job description to the recruiter, in accordance with an embodiment of the present disclosure;

FIG. 5 is a process flow diagram illustrating steps involved in an exemplary Artificial Intelligence based resume builder method for creating user customized visual resume, in accordance with an embodiment of the present disclosure; and

FIG. 6 is a process flow diagram illustrating steps involved in an exemplary Artificial Intelligence based resume builder method for segregating visual resumes for the job description to the recruiter, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention. It will be understood by those skilled in the art that the foregoing general description and the following detailed description are exemplary and explanatory of the invention and are not intended to be restrictive thereof.

The terms “comprise”, “comprising”, or any other variations thereof, are intended to cover a non-exclusive inclusion, such that one or more devices or submodules or elements or structures or components preceded by “comprises . . . a” does not, without more constraints, preclude the existence of other devices, sub-systems, additional submodules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting. Embodiments of the present invention will be described below in detail with reference to the accompanying figures.

A computer system (standalone, client or server computer system) configured by an application may constitute a “submodule” that is configured and operated to perform certain operations. In one embodiment, the “submodule” may be implemented mechanically or electronically, so a submodule may comprise dedicated circuitry or logic that is permanently configured (within a special-purpose processor) to perform certain operations. In another embodiment, a “submodule” may also comprise programmable logic or circuitry (as encompassed within a general-purpose processor or other programmable processor) that is temporarily configured by software to perform certain operations.

Accordingly, the term “submodule” should be understood to encompass a tangible entity, be that an entity that is physically constructed permanently configured (hardwired) or temporarily configured (programmed) to operate in a certain manner and/or to perform certain operations described herein.

The present disclosure completely changes the way resumes are created, shared and consumed, by providing portals for visual resume creation and shortlisting of resume based on a job description. Users are provided with intuitive touch based visual resume builder application using which the resume can be created which can showcase an entire spectrum of skill set possessed by a candidate. A normalized view of applicant's skill set is also showcased in the visual resume.

When a user creates visual resume, based on his domain expertise or based on job application, an artificial intelligence-based resume builder system populates the entire spectrum of specified domain for the convenience of the user. Using the touch interface, user needs to drag and plot his associated skill set metric. Once the user specifies rating, he needs to provide justification for the specified rating. Justification can be provided in multiple ways. it is up to the user to select the most appropriate once. All along the duration of visual resume creation, the artificial intelligence-based resume builder system helps the user to rate his skill set appropriately. After entering all the data, an artificial intelligence-based data normalization technique appropriately normalise the user skill set rating.

The present disclosure further improves recruitment or hiring processes, by leveraging a job description (JD) posting in a graphical manner. The recruiters provide domain or multiple domains they are hiring for, along with the skill set they are expecting in the prospective candidate. The Artificial Intelligence based resume builder system generates a report based on the job description created. Further, hiring manager can adjust one or more skill requirements for the job description based on the availability of candidates. Alternatively, hiring managers may also prescribe or add value to data normalization.

In accordance with an embodiment of the present disclosure, an artificial intelligence-based resume builder system and method for creating user customized visual resume is disclosed. The system includes a memory coupled to the one or more hardware processors. The memory includes a plurality of submodules in the form of programmable instructions executable by the one or more hardware processors. The plurality of submodules includes a job role receiver submodule, a skill receiver submodule, a recorder submodule, a skill-set rating submodule, a normalization submodule, and a resume generator submodule.

The job role receiver submodule is configured to receive one or more job roles from a user. The skill receiver submodule is configured to receive one or more skills from the user corresponding to each of the one or more job roles. The recorder submodule is configured to record one or more documental proofs from the user corresponding to each of the one or more skills. The skill-set rating submodule is configured to receive a first rating from the user for each of the one or more skills, and to generate a second rating for each of the one or more skills by examining the one or more documental proofs based on one or more predefined criteria.

The normalization submodule is configured to determine a final rating for each of the one or more skills by normalizing the first rating and the second rating corresponding to each of the one or more skills using an artificial intelligence-based data normalization technique. The resume generator submodule is configured to generate a visual resume based on the one or more job roles received from the user, the one or more skills received from the user corresponding to the one or more job roles, and a final rating determined for each of one or more skills. The visual resume includes a graphical representation of the one or more skills corresponding to each of the job roles.

Further, the artificial intelligence-based resume builder system also segregates one or more visual resumes for a job description to the recruiter. To segregate the one or more visual resumes for a job description, the artificial intelligence-based resume builder system includes a job description ranking submodule to receive a job description from a recruiter and to determine a skill ranking for each of the one or more skills corresponding to the job description based on one or more predefined job description (JD) criteria.

A resume segregator submodule is provided to segregate the one or more visual resumes created by the one or more users for the job description. The one or more visual resumes are segregated by comparing skill ranking for each of the one or more skills required for the job description with the final skill ranking of the corresponding each of the one or more skills in each of the one or more visual resumes. A recruiter display submodule is to display the one or more visual resumes segregated for the job description to the recruiter.

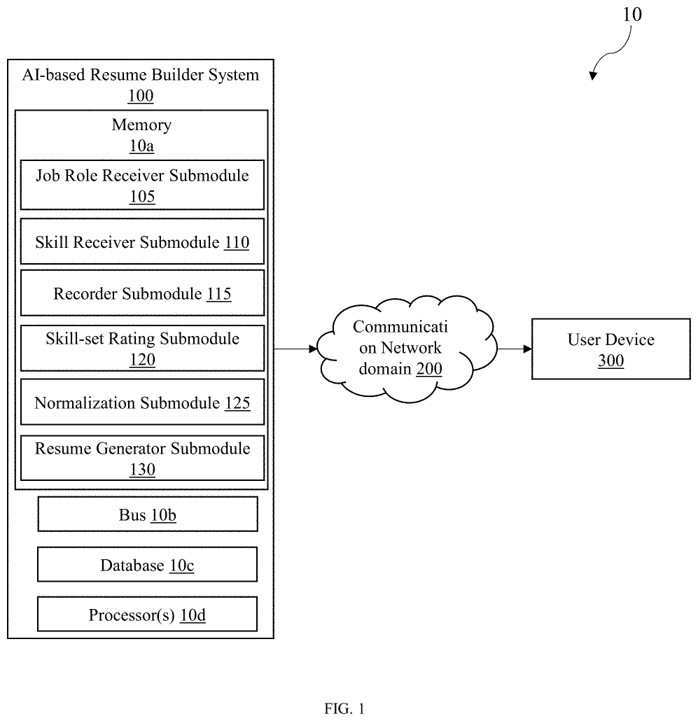

FIG. 1 is a block diagram illustrating an exemplary computing environment 10 for creating user customized visual resume, in accordance with an embodiment of the present disclosure. According to FIG. 1, the computing environment 10 includes an artificial intelligence (AI)-based resume builder system 100 which interacts with a user associated with a user device 300 (i.e.—user device such as laptop computer, desktop computer, tablet computer, smartphone, and the like) via a communication network 200 (i.e.—internet, Wi-Fi, and the like).

The artificial intelligence-based resume builder system 100 includes one or more hardware processor 10d, a database 10c, and a memory 10a. The one or more hardware processor 10d may be communicatively coupled to the memory 10a and the database 10c via a system bus such as a system bus 10b or a similar mechanism. The one or more hardware processor(s) 10d, as used herein, is comprised of any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processor(s) 10d may also include embedded controllers such as generic or programmable logic devices or arrays, application specific integrated circuits, single-chip computers, and the like.

The memory 10a may be non-transitory volatile memory or non-volatile memory. The memory 10a may be coupled to communicate with the one or more hardware processors 10d, such as being a computer-readable storage medium. The one or more hardware processors 10d may execute machine-readable instructions and/or source code stored in the memory 10a. A variety of machine-readable instructions may be stored in, and accessed from, the memory 10a. The memory 10a may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 10a includes a plurality of submodules stored in the form of machine-readable instructions on any of the above-mentioned storage media and may be in communication with and executed by the one or more hardware processor(s) 10d.

The memory 10a includes a plurality of submodules in the form of programmable instructions executable by the one or more hardware processors 10d. The plurality of submodules includes a job role receiver submodule 105, a skill receiver submodule 110, a recorder submodule 115, a skill-set rating submodule 120, a normalization submodule 125, and a resume generator submodule 130.

The database 10c stores information relating to the computing environment 10 and the user device(s 300. The database 10c is, for example, a structured query language (SQL) data store. The database 10c is configured as database implemented in the computing environment 10, and a service is delivered over a communication network domain 200. The database 10c, according to another embodiment of the present disclosure, is a location on a file system directly accessible by the plurality of submodules.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of an artificial intelligence-based resume builder system 100 as is unique to the present disclosure or necessary for an understanding of the present disclosure is depicted and described. The remainder of the construction and operation of the artificial intelligence-based resume builder system 100 may conform to any of the various current implementation and practices known in the art.

The job role receiver submodule 105 is configured to receive one or more job roles from one or more users. The one or more job roles may include developer, analyst, consultant, accountant, administrator, manager and the like. The skill receiver submodule 110 is configured to receive one or more skills (such as programming, accountancy, documentation, etc). from the user corresponding to each of the one or more job roles. The recorder submodule 115 is configured to record one or more documental proofs. The one or more documental proofs include certificates, grades, experience letter, etc. from the user corresponding to each of the one or more skills. The one or more documental proofs from the user includes a work experience, a level of skill training, a level of certification, and a grade obtained by the user corresponding to each of the one or more skills. The skill-set rating submodule 120 is configured to receive a first rating from the user for each of the one or more skills, and to generate a second rating for each of the one or more skills by examining the one or more documental proofs based on one or predefined criteria.

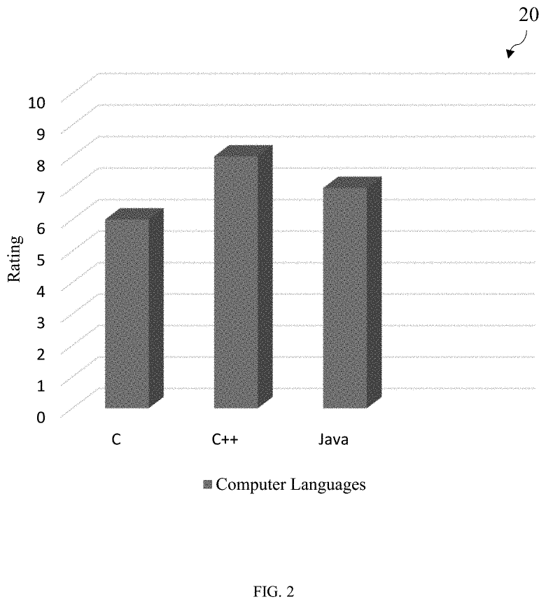

The normalization submodule 125 is configured to determine a final rating for each of the one or more skills by normalizing the first rating and the second rating corresponding to each of the one or more skills using an artificial intelligence-based data normalization technique. The resume generator submodule 130 is configured to generate a visual resume based on the one or more job roles received from the user, the one or more skills received from the user corresponding to the one or more job roles, and the one or more final ratings determined for each of one or more skills. The visual resume includes a graphical representation [as illustrated in FIG. 2] of the one or more skills corresponding to each of the job roles.

FIG. 2 is illustrating an exemplary graphical representation 20 of one or more skills, created by the artificial intelligence-based resume builder system 100, in accordance with an embodiment of the present disclosure. The exemplary graphical representation 20 illustrates proficiency in computer languages—C, C⁺⁺ and Java as the one or more skills corresponding to a job role of software developer. The graphical representation 20 is in the form of a bar chart. In the bar chart, the final rating of the one or more skills (C, C⁺⁺ and Java) is indicated as 6, 8, and 7 respectively, on the scale of 10. In another exemplary embodiments, the graphical representation of the one or more skills may include depiction of one or more final ratings of the skills in the form of any two-dimensional (2-D) graph, three-dimensional (3-D) graph, and animated graph chart such as a bar chart, a pie chart, a line chart, a histogram chart, an area chart, a dot graph, a scatter plot, a bubble chart and the like.

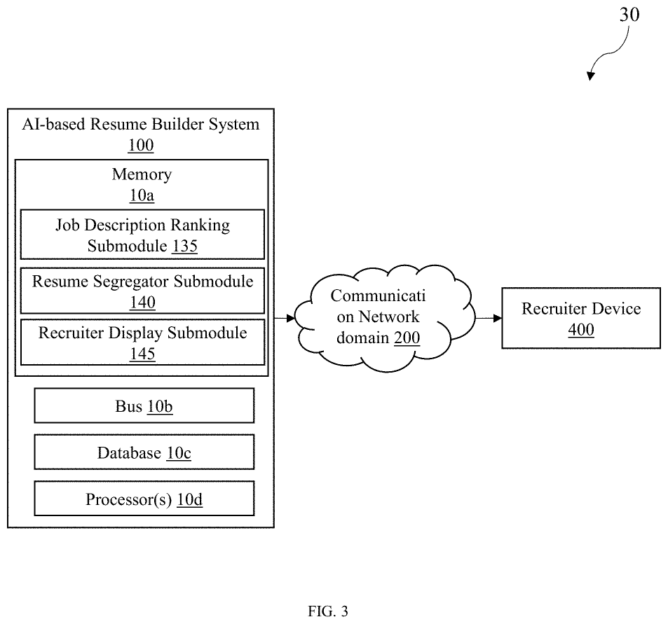

FIG. 3 is a block diagram illustrating an exemplary artificial intelligence-based resume builder system 100 for segregating one or more visual resumes for a job description to the recruiter, in accordance with an embodiment of the present disclosure. According to FIG. 2, the computing environment 20 includes an artificial intelligence-based resume builder system 100 which interacts with a recruiter 400 via a communication network 200. The recruiter device may include laptop computer, desktop computer, tablet computer, smartphone, and the like. The communication network 200 may include internet, Wi-Fi, and the like. To segregate the one or more visual resumes for a job description, the plurality of submodules of the artificial intelligence-based resume builder system 100 includes a job description ranking submodule 135, a resume segregator submodule 140 and a recruiter display submodule 145. The job description ranking submodule 135 is configured to receive a job description from a recruiter and to determine a skill ranking for each of the one or more skills corresponding to the job description based on one or more predefined job description (JD) criteria. The job description ranking module 135 is further configured to receive an update or modification in the skill ranking from the recruiter, for each of the one or more skills.

The resume segregator submodule 140 is provided which is executable by the one or more hardware processors and configured to segregate the one or more visual resumes created by the one or more users for the job description. The one or more visual resumes are segregated by comparing the skill ranking for each of the one or more skills required for the job description with the final skill ranking of the corresponding each of the one or more skills in each of the one or more visual resumes. The recruiter display submodule 145 is provided which is executable by the one or more hardware processors and configured to display the one or more visual resumes segregated for the job description to the recruiter.

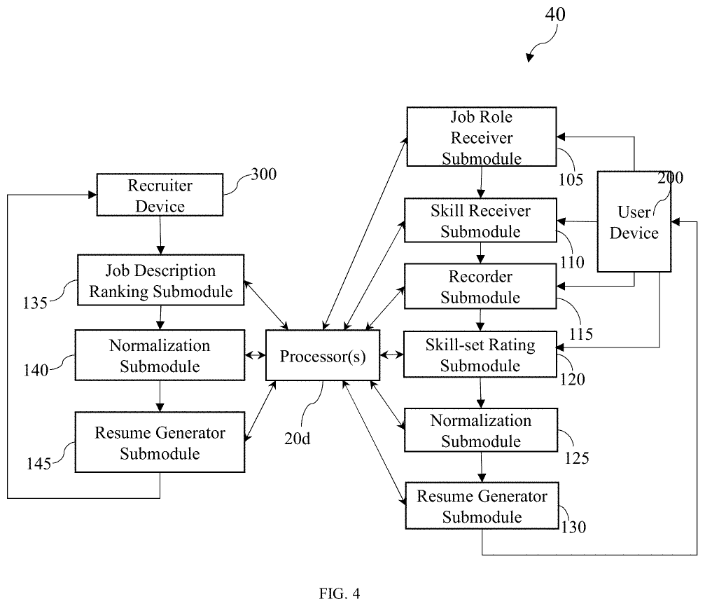

FIG. 4 is a block diagram illustrating an exemplary processing environment for creating user customized visual resume and for segregating visual resumes for a job description to a recruiter, in accordance with an embodiment of the present disclosure. For creating user customized visual resume, the memory includes the plurality of submodules including the job role receiver submodule 105, the skill receiver submodule 110, the recorder submodule 115, the skill-set rating submodule 120, the normalization submodule 125, and the resume generator submodule 130, which are communicatively coupled with the processor(s) 10d to process one or more data received from the user.

The one or more data from the user is received at the job role receiver submodule 105, the skill receiver submodule 110, the recorder submodule 115, and the skill-set rating submodule 120. Further, after processing of the one or more data from user by the plurality of submodules, the resume generator module 130 finally generates the visual resume including the graphical representation of the one or more skills corresponding to each of the job roles.

For segregating one or more visual resumes for a job description to the recruiter, the memory includes the plurality of submodules including the job description ranking submodule 135, the resume segregator submodule 140 and the recruiter display submodule 145, which are communicatively coupled with the processor(s) 10d to process one or more data received from the user. The one or more data from the recruiter is received at the job description ranking submodule 135. Further, after processing of the one or more data from recruiter by the plurality of submodules (the job description ranking submodule 135 and the resume segregator submodule 140), the recruiter display submodule 145 finally displays the one or more visual resumes segregated corresponding to the job description to the recruiter.

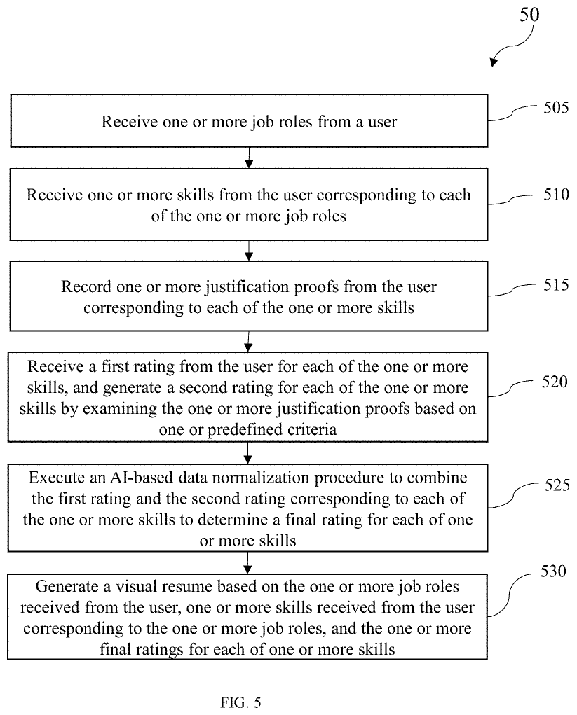

FIG. 5 is a process flow diagram illustrating steps involved in an exemplary artificial intelligence-based resume builder method 50 for creating user customized visual resume, in accordance with an embodiment of the present disclosure. The artificial intelligence-based resume builder method 50 includes first step of receiving 505, by a job role receiver module executable by one or more hardware processors, one or more job roles from a user. The artificial intelligence-based resume builder method 50 includes second step of receiving 510, by a skill receiver module executable by the one or more hardware processors, one or more skills from the user corresponding to each of the one or more job roles.

The artificial intelligence-based resume builder method 50 includes third step of recording 515, by a recorder module executable by the one or more hardware processors, one or more documental proofs from the user corresponding to each of the one or more skills. The one or more documental proofs from the user includes a work experience, a level of skill training, a certification, and a grade obtained by the user corresponding to each of the one or more skills.

The artificial intelligence-based resume builder method 50 includes fourth step of receiving 520, by a skill-set rating module executable by the one or more hardware processors, a first rating from the user for each of the one or more skills, and generating, by the skill-set rating module, a second rating for each of the one or more skills by examining the one or more documental proofs based on one or predefined criteria. The artificial intelligence-based resume builder method 50 includes fifth step of executing 525, by a normalization module executable by the one or more hardware processors, an artificial intelligence-based data normalization procedure to combine the first rating and the second rating corresponding to each of the one or more skills to determine a final rating for each of the one or more skills.

The artificial intelligence-based resume builder method 50 includes sixth step of generating 530, by a resume generator module executable by the one or more hardware processors, a visual resume based on the one or more job roles received from the user, the one or more skills received from the user corresponding to the one or more job roles, and the one or more final ratings determined for each of the one or more skills. The visual resume includes a graphical representation of the one or more skills corresponding to each of the job roles. The graphical representation of the one or more skills includes depiction of the one or more final ratings of the skills in the form of any two-dimensional (2-D) graph, three-dimensional (3-D) graph, or animated graph chart such as a bar chart, pie chart, line chart, histogram chart, area chart, dot graph, scatter plot, bubble chart, and the like.

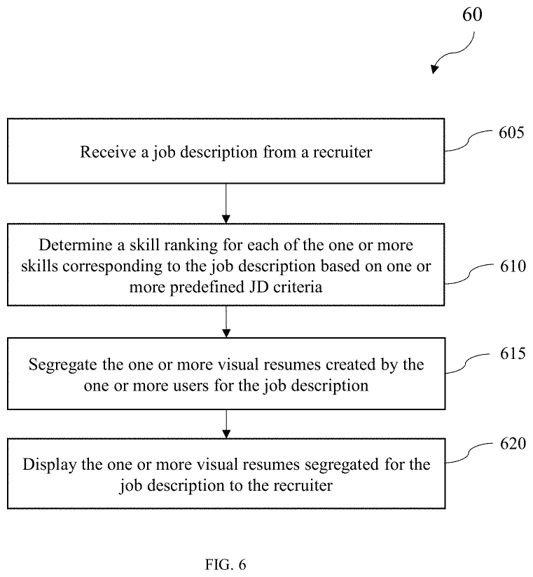

FIG. 6 is a process flow diagram illustrating steps involved in an exemplary artificial intelligence-based resume builder method for segregating visual resumes for the job description to the recruiter, in accordance with an embodiment of the present disclosure. The artificial intelligence-based resume builder method 60 includes first step of receiving 605, by a job description ranking module executable by the one or more hardware processors, a job description from a recruiter. The artificial intelligence-based resume builder method 60 includes second step of determining 610, by the job description ranking module, a skill ranking for each of the one or more skills corresponding to the job description based on one or more predefined JD criteria. In determining 610, a skill ranking for each of the one or more skills, the artificial intelligence-based resume builder method 60 further includes receiving an update/modification in the skill ranking for each of the one or more skills by the job description ranking module.

The artificial intelligence-based resume builder method 60 includes third step of segregating 615, by a resume segregator module executable by the one or more hardware processors, the one or more visual resumes created by the one or more users for the job description. The one or more visual resumes are segregated by comparing skill ranking for each of the one or more skills required for the job description with the final skill ranking of the corresponding each of the one or more skills in each of the one or more visual resumes. The artificial intelligence-based resume builder method 60 includes fourth step of displaying 620, by a recruiter display module executable by the one or more hardware processors, the one or more visual resumes segregated for the job description to the recruiter.

Various embodiments of the present system provide a technical solution to create visual resumes for applicants and to segregate the visual resumes as per job description for recruiters. General resumes are quite open ended and are not bound to technical area. The present disclosure creates resumes which are closely bound with technological lifecycle, to bring out the real and the most accurate skill set of the applicants. Secondly, Visual resumes created are much more readable, understandable and expressible. Only fewer sentences are required to explain the applicant's viewpoint related to career history. The system and the method disclosed are quite intuitive and support multiple interfaces (Web/mobile) and easy to use.

The following advantages are obtained through the present disclosure:

Resume Builder Suggestion: —The artificial intelligence-based resume builder system and method suggests user in defining closest matching skills with respect to his profile. When the user change the skill set scale an auto suggestion or comments are popped to help to finalize his rating.

Profile Shortlisting: —Human resource manager or hiring managers receive thousands to profile every day, utilizing the present disclosure, each of the resumes reduce into mathematical equation. The artificial intelligence-based resume builder system and method provides best matching profile for the further processing.

Resume Reading: —Given the visual way of representing the entire career history, the present disclosure makes it easier for hiring manager to understand the background and technical skill sets.

Skill Normalization: —The artificial intelligence-based resume builder system and method constantly normalizes the user data helping users to identify if the skill set level they have, is getting change in increasing or decreasing.

Resume updates: —The user resume constantly gets updated post skill normalize by the artificial intelligence-based resume builder system and method, even if user is not applying for the jobs.

Application Data: —Through the present disclosure organizations get real time data to indicate how many candidates are available for specific job vacancy, they are hiring for, and helps them to make accurate and timely decision.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. An artificial intelligence (AI) based resume builder system to create user customized visual resume, the artificial intelligence-based resume builder system comprising:
one or more hardware processors; and
a memory coupled to the one or more hardware processors, wherein the memory comprises a plurality of submodules in the form of programmable instructions executable by the one or more hardware processors, wherein the plurality of submodules comprises:
a job role receiver submodule configured to receive one or more job roles from a user;
a skill receiver submodule configured to receive one or more skills from the user corresponding to each of the one or more job roles;
a recorder submodule configured to record one or more documental proofs from the user corresponding to each of the one or more skills;
a skill-set rating submodule configured to receive a first rating from the user for each of the one or more skills, and to generate a second rating for each of the one or more skills by examining the one or more documental proofs based on one or predefined criteria;
a normalization submodule configured to determine a final rating for each of the one or more skills by normalizing the first rating and the second rating corresponding to each of the one or more skills using an artificial intelligence-based data normalization technique; and
a resume generator submodule configured to generate a visual resume based on the one or more job roles received from the user, the one or more skills received from the user corresponding to the one or more job roles, and a final rating determined for each of the one or more skills,
wherein the visual resume comprises a graphical representation of the one or more skills corresponding to each of the job roles.

2. The artificial intelligence-based resume builder system as claimed in claim 1, wherein the one or more documental proofs from the user comprises a work experience, a level of skill training, a level of certification, and a grade obtained by the user corresponding to each of the one or more skills.

3. The artificial intelligence-based resume builder system as claimed in claim 1, wherein the graphical representation of the one or more skills comprises depiction of the final rating in the form of one of a two-dimensional (2-D) graph, three-dimensional (3-D) graph, and animated graph chart such as a bar chart, a pie chart, a line chart, a histogram chart, an area chart, a dot graph, a scatter plot, a bubble chart and the like.

4. The artificial intelligence-based resume builder system as claimed in claim 1, wherein the artificial intelligence-based resume builder system further comprises:
a job description ranking submodule executable by the one or more hardware processors and configured to receive a job description from a recruiter and to determine a skill ranking for each of the one or more skills corresponding to the job description based on one or more predefined job description (JD) criteria;
a resume segregator submodule executable by the one or more hardware processors and configured to segregate one or more visual resumes created by one or more users for the job description, wherein the one or more visual resumes are segregated by comparing the skill ranking for each of the one or more skills required for the job description with the final rating of the corresponding each of the one or more skills in each of the one or more visual resumes; and
a recruiter display submodule executable by the one or more hardware processors and configured to display the one or more visual resumes segregated for the job description to the recruiter.

5. The artificial intelligence-based resume builder system as claimed in claim 4, wherein the job description ranking submodule is configured to receive an update in the skill ranking for each of the one or more skills.

6. An artificial intelligence-based resume builder method to create user customized visual resume, the artificial intelligence-based resume builder method comprising:
receiving, by a job role receiver submodule executable by one or more hardware processors, one or more job roles from a user;
receiving, by a skill receiver submodule executable by the one or more hardware processors, one or more skills from the user corresponding to each of the one or more job roles;
recording, by a recorder submodule executable by the one or more hardware processors, one or more documental proofs from the user corresponding to each of the one or more skills;
receiving, by a skill-set rating submodule executable by the one or more hardware processors, a first rating from the user for each of the one or more skills, and generating, by the skill-set rating submodule, a second rating for each of the one or more skills by examining the one or more documental proofs based on one or predefined criteria;
determining, by a normalization submodule executable by the one or more hardware processors, a final rating for each of the one or more skills by normalizing the first rating and the second rating corresponding to each of the one or more skills using an artificial intelligence-based data normalization technique; and
generating, by a resume generator submodule executable by the one or more hardware processors, a visual resume based on the one or more job roles received from the user, the one or more skills received from the user corresponding to the one or more job roles, and a final rating determined for each of the one or more skills,
wherein the visual resume comprises a graphical representation of the one or more skills corresponding to each of the job roles.

7. The artificial intelligence-based resume builder method as claimed in claim 6, wherein the one or more documental proofs from the user comprises a work experience, a level of skill training, a certification, and a grade obtained by the user corresponding to each of the one or more skills.

8. The artificial intelligence-based resume builder method as claimed in claim 6, wherein the graphical representation of the one or more skills comprises depiction of the final rating in the form of one of a bar chart, pie chart, line chart, histogram chart, area chart, dot graph, scatter plot, bubble chart, 2-D graph, 3-D graph, and animated graph chart.

9. The artificial intelligence-based resume builder method as claimed in claim 6, wherein the artificial intelligence-based resume builder method further comprises:
receiving, by a job description ranking submodule executable by the one or more hardware processors, a job description from a recruiter and determining, by the job description ranking submodule, a skill ranking for each of the one or more skills corresponding to the job description based on one or more predefined JD criteria;
segregating, by a resume segregator submodule executable by the one or more hardware processors, one or more visual resumes created by one or more users for the job description, wherein the one or more visual resumes are segregated by comparing the skill ranking for each of the one or more skills required for the job description with the final rating of the corresponding each of the one or more skills in each of the one or more visual resumes; and
displaying, by a recruiter display submodule executable by the one or more hardware processors, the one or more visual resumes segregated for the job description to the recruiter.

10. The artificial intelligence-based resume builder method as claimed in claim 9, wherein further comprising receiving an update in the skill ranking for each of the one or more skills by the job description ranking submodule.
